(19) United States
(12) Patent Application Publication
(10) Pub. No.: US 2005/0022127 A1
(43) Pub. Date: Jan. 27, 2005

(54) ENHANCED MEDIA PLAYER

(76) Inventors: Glenn R. Meyers, Denver, CO (US); Greg Smith, Denver, CO (US)

Correspondence Address: GLENN L. WEBB, P.O BOX 951, CONIFER, CO, 80433, US

(21) Appl. No.: 10/710,614

(22) Filed: Jul. 23, 2004

Related U.S. Application Data
(60) Provisional application No. 60/481,129, filed on Jul. 23, 2003.

(51) Int. Cl. G09G 5/00

(52) U.S. Cl. 715/716; 715/720; 715/717; 715/721; 715/810; 715/825

(57) ABSTRACT

An indexable media player for providing various forms of communications in synchronized form from a remote host. The media player includes a video window, a content window and interactive windows to allow a user to communicate with the remote host. The media player also includes an indexable menu to allow users to select a desired segment for communication. An interactive component also allows collaborative interaction between the users and host of the media communication.

### RELATED APPLICATIONS

This application relates to the subject matter of provisional application 60/481,129 filed on Jul. 23, 2003.

### BACKGROUND OF INVENTION

The sharing of information has been historically a critical component of modern development. The process of sharing information has evolved from verbal communications, to printing documents, and now has exploded to encompass electronic communication formats such as radio, television and computer systems.

Communication systems are widely used today to present information in varying formats. One popular communication system is through electronic formats, including but not limited to networked communications, telecommunications, radio, television, satellite, wireless and other forms as well as media such as compact discs, DVD's and other types of media. Also, information may be presented through many different formats such as but not limited to audio, video, graphic, pictorial, text, and music. Each of these types of media formats may be relayed to users through interfaces such as media players. While media players may include specialized interfaces such as electronic devices (receivers, personal stereos, televisions, and other common devices), increasingly more media is being transmitted for viewing through browser interfaces for use on computers, personal digital assistants and even mixed media telephones. These browser interfaces are commonly referred to as media players.

Presently there are a number of media players on the market for viewing communications on a browser interface. These media players are able to play either files, such as audio or video clips in wav, MPEG or other types of formats, streaming media and other communications. Typically these media players allow clips or uniform resource locators (URL) to be organized in a play list or jukebox. A person using the media player can select among the clips or URLS as well as play, stop, rewind or fast forward. Popular forms of these media players are Quicktime by Apple, Windows Media Player by Microsoft and RealOne players by RealNetworks. These media players are displayed through browsers such as Microsoft Windows, Netscape, Mozilla or other browsers.

These media players open stored files and play the contents of those files. The file directories are displayed as hierarchical listing of the flat files in the form of play lists or are accessible by opening a file menu. Individual segments of the files are not accessible. That is, if a user desires to go directly to a segment of a media file, they must fast forward or rewind until that segment plays.

Another problem with existing media player technology is that they do not allow for interactivity with the user. The media player simply opens stored files located on a computer, hardware device or server. The user is not able to send back information to the host of the media player content.

Also, these media players do not provide synchronized information of different media segments. That is there is no synchronization between a video presentation and text information that may related to that video presentation or other types of media being presented. Further, these media players do not provide an encoded package of communications with a customized media player.

Thus a need exists for a media player that will allow information to be presented to a user in a plurality of synchronized media formats and to allow interactive communications between the user and the host or other users.

### SUMMARY OF INVENTION

In a preferred embodiment, the media player uses a browser interface in an electronic environment, such as a computer monitor, television screen, personal digital assistant, telephone or any other suitable environment. The browser may also operate on audio devices, such as receivers, stereos, automotive stereos, personal stereo devices, and the like. For purposes of this application, the term media player is defined as a platform for delivering media to a user through a user interface.

The present invention, in a preferred embodiment, provides a hosted media player for use in customized communications. The present invention, in a preferred embodiment, includes an on-demand platform or with a live scheduled host, that can be used as a hosted media player.

This preferred embodiment of the present invention provides the capability for a user to participate in communications from a hosted server in a variety of ways. The communications may include but are not limited to audio, video, graphic, pictorial, text, music and other forms, and may be provided in combinations with one another as well as synchronized with one another. The user may, by use of features of this media player of this preferred embodiment, easily reference and use different components of the communication through an indexable menu. This enables a user to go directly to the content component of interest rather than fast forward through intervening content components.

The present invention, in a preferred embodiment of the present invention, is provides interactivity between the host and a user of the media player. The interactivity may be by an instant messenger component, e-mail, or even an audio or video transmission or any other transmission technology that is presently available or that is foreseeably developed.

In one particular component of a preferred embodiment, the media player provides a window for instant feedback between the host and the user. This component is particularly useful in distance learning environments. The user can then pose questions on the content and obtain instant feedback from the host. Also, the host can provide instant feedback on answers to test questions through the media player.

Another preferred embodiment provides interactivity not only with the host but with other users of the media player. This creates a collaborative environment that allows instant or near-instant communications during the media presentation.

Another preferred embodiment provides a media player that includes an indexable selection menu. The user is able to select a particular segment of the media presentation. That selection is then presented. This eliminates the need to fast forward or reverse play the media presentation in order to present that particular segment of interest.

These and other features will be evident from the ensuing description of preferred embodiments and from the drawings.

### BRIEF DESCRIPTION OF DRAWINGS

FIG. 1 illustrates a schematic of a preferred embodiment of the present invention.

FIG. 2 illustrates a media player of the preferred embodiment of the present invention.

FIG. 3 illustrates select features of the media player of FIG. 2.

FIG. 4 illustrates the indexable menu of the media player of FIG. 2.

FIG. 5 is an illustration of a synchronized timeline of content delivery.

### DETAILED DESCRIPTION

The present invention, in a preferred embodiment, provides a hosted media player for use in customized communications. A preferred embodiment of the present invention is described below. It is to be expressly understood that this descriptive embodiment is provided for explanatory purposes only, and is not meant to unduly limit the scope of the present invention as set forth herein. Other embodiments of the present invention are considered to be within the scope of the invention, including not only those embodiments that would be within the scope of one skilled in the art, but also as encompassed in technology developed in the future.

The present invention, in a preferred embodiment, includes an on-demand platform that can be used as a hosted media player. In this embodiment, the media player uses a browser interface in an electronic environment, such as a computer monitor, television screen, personal digital assistant, telephone or any other suitable environment. The browser may also operate on audio devices, such as receivers, stereos, automotive stereos, personal stereo devices, and the like. For purposes of this application, the term media player is defined as a platform for delivering media to a user through a user interface.

This preferred embodiment of the present invention provides the capability for a user to participate in communications from a hosted server in a variety of ways. The communications may include but are not limited to audio, video, graphic, pictorial, text, music and other forms, and may be provided in combinations with one another as well as synchronized with one another. The user may, by use of features of this media player of this preferred embodiment, easily reference and use different components of the communication through an indexable menu. This enables a user to go directly to the content component of interest rather than fast forward through intervening content components.

The present invention, in a preferred embodiment of the present invention, is provides interactivity between the host and a user of the media player. The interactivity may be by an instant messenger component, e-mail, or even an audio or video transmission or any other transmission technology that is presently available or that is foreseeably developed.

In one particular component of a preferred embodiment, the media player provides a window for instant feedback between the host and the user. This component is particularly useful in distance learning environments. The user can then pose questions on the content and obtain instant feedback from the host. Also, the host can provide instant feedback on answers to test questions through the media player.

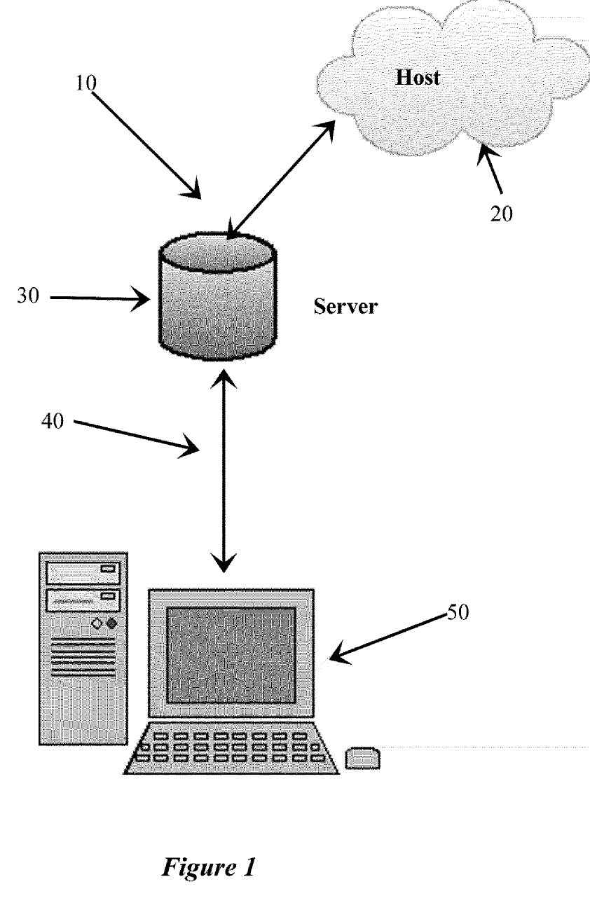

A preferred embodiment of the present invention is illustrated in FIGS. 1 4. A schematic of this preferred embodiment of a hosted media player 10 is shown in FIG. 1. A host 20 provides content, either live or stored on server 30. The content is distributed using streaming technology or other suitable technology now present or hereafter developed to the media player interface 50. The distribution can occur over networks, intranets, by way of the Internet or other global networks, by satellite, telecommunications lines, wireless telecommunications, television, or any other suitable broadband distribution schemes now present or hereafter developed. The distribution may also include media such as compact discs, DVD, CDR and other forms of media that may be distributed that are presently available or later developed.

The particular implementation of the media player may be by Microsoft Windows technology, particularly with ActiveX components of the Windows Media Player. Alternatively, the media player interface may be implemented by Macromedia Flash technology or by other technologies that are presently available or that will be available in the future. The media player may be utilized with Internet browsers such as Windows Explorer, Netscape, Mozilla, or any other available browser that supports the technology of the media player of the present invention.

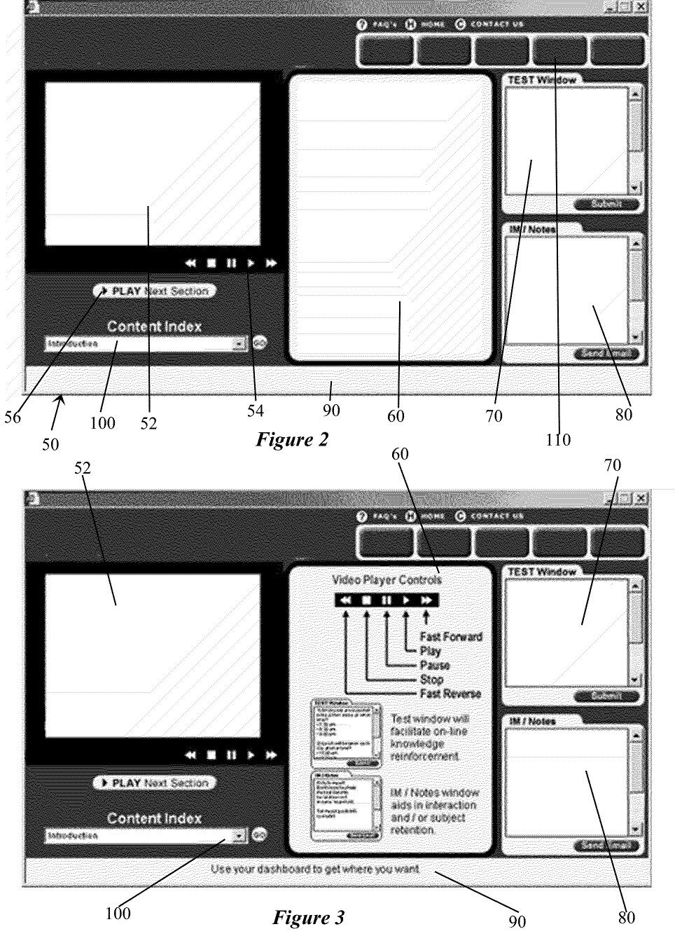

The media player interface 50 of the preferred embodiment of the present invention is an on-demand platform that can be instantiated on most if not all computer platforms, as well as on audio devices, video devices, including television, telephone, personal digital assistants, textual display devices, and other electronic devices. The media player interface 50, shown in FIG. 2, includes a video window 52 that allows streaming video to be played. Dashboard controls 54 provide the user with the ability to play, stop, pause, fast forward and rewind the video content displayed in the video window. The user may also skip sections of the presentation with control 56. Information on audio segments may also be displayed in the video window 52. A help menu is also provided.

The media player 50 also includes a content window 60. Content window 60 provides graphical, textual or pictorial information to the user. This information may be synchronized with the video/audio content being displayed in the accompanying video window 52. This provides additional sensory input by combining the audio/video content with the textual/pictorial/graphical information. Also, the content window may include footnotes or annotations to go along with an audio/video presentation. As shown in FIG. 3, the content window 60 may also include assistance via the help menu, or other information as well.

Another feature of a preferred embodiment of the present invention is an interactive capability. The media player 50 of this preferred embodiment includes an interactive window 70. This interactive window provides feedback to the host. For example, the interactive window may include a test site, for distance learning, that provides feedback to the host on how well the user/student is learning the material presented in the audio/video window 52 and/or the content window 60.

Another interactive feedback window 80 is also shown in the embodiment illustrated in FIG. 2. This feedback window allows the user to utilize instant messaging, email or other forms of communication, such as video or audio conferencing to provide information back to the host, or even possibly to others utilizing the hosted communications.

In a preferred embodiment, the media player 50 allows three types of communication. The first communication type is one-way delivery of the media. This may be in the form of synchronized media contents that allows a user to receive the content but not interact with the host. The second communication type is two-way delivery of the media. As discussed above, this provides interactive feedback windows to allow the user not only to receive the content but to provide information back to the host or to other users receiving the content. The third communication type is two-way delivery along with access to content from a third site. For example, a live host may be providing content from a remote database to media player users that may interact with the live host as well as the content from the remote database.

Another preferred embodiment of the present invention provides a collaborative component. The collaborative component allows multiple users to interact with one another. One version of the collaborative component utilizes instant messaging technology, such as Microsoft NET messenger, AOL Instant Messenger or other types of instant messaging technology including but not limited to Common Presence and Instant Messaging (CPIM) protocols to interact with one another. The media player may either utilize an existing instant messaging server or act as an instant messaging server. The instant messaging server stores the connection information for the client device, such as the IP address of the client device and the port number that is assigned to the instant messaging application at the client device.

Typically, the instant messaging server also receives and stores an IM contact list for the user along with the user's connection information and other session information. The server performs an initial check to see if the users in the IM contact list are online and notifies the user's active instant messaging client of the online status of those users, e.g., whether those users are online and available for communication through the instant messaging system. The server monitors these IM contact lists such that when a user logs into the instant messaging system, the server notifies anyone who has the recently logged-in user within a IM contact list that the recently logged-in user is now online. In this manner, instant messaging users are constantly aware of the online status of the users within their IM contact lists. When the instant messaging server notifies a first instant messaging client that a second instant messaging client is online, the instant messaging server sends the connection information for the second instant messaging client to the first instant messaging client and perhaps vice versa depending upon the online status of the user. Because each active instant messaging client has connection information for other active instant messaging clients in the instant messaging system, these instant messaging clients can transfer instant messages between themselves without interaction with the instant messaging server, i.e. in a peer-to-peer manner.

Another version utilizes peer-to-peer networking to transmit interactive materials between the users. The media player provides the connection information for the users to each of the users. In that manner, the users do not need to interact with an instant messaging server.

In either the instant messaging embodiment or the peer-to-peer embodiment, messages between the users are displayed on a window on the media player interface. Also, the message sender is identified as well as other users participating in the communication.

Another preferred embodiment of the present invention provides collaborative interaction between the users by providing the user's email addresses to each of the users. In that manner the system allows the users to email one another using POP, SMTP or other protocols. The email may be displayed in a window on the media player interface or in the email component of the browser.

Another preferred embodiment provides a chat room environment provides a chat room for the users to allow multiple interactions between the users. The media player provides a platform or host for the chat room simultaneously with the delivery of the communication. A window displays text information from the users during, before and after the communication delivery.

In a preferred embodiment shown in FIG. 2, the media player 50 also includes a footer screen 90. This footer screen 90 provides synchronous speaker highlights, copy highlights, or information about the content being displayed in any of the windows on the media player.

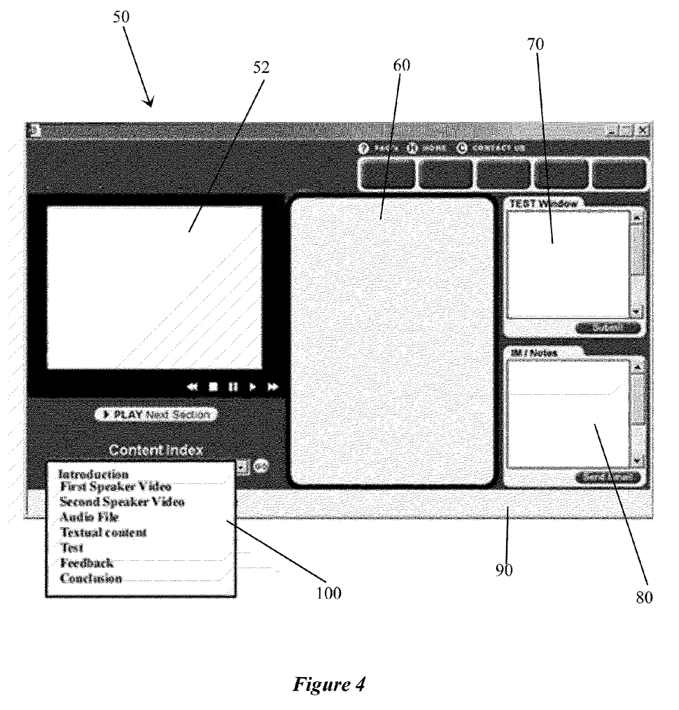

An important feature of the preferred embodiment of the present invention is illustrated in FIGS. 2 and 4. An indexable menu selection 100 is used to allow the user to access directly to a selected content component. For example, as shown in FIG. 4, the user may select the indexable menu selection 100 to activate a drop down selection of available content components. The user may then select the desired content component which causes that selection to be brought into the appropriate window. This is only an example of the types of indexable menu windows that may be utilized under the present invention. It is to be expressly understood that other formats and embodiments of indexable menu windows may be covered under the present invention.

Another feature of the preferred embodiment includes the use of menu buttons 110 at the top of the media player 50. These menu buttons may be linked to related host server sites, webpage sites or hardwired to selected information components.

Exemplary Implementation

An example of an implementation of a preferred embodiment is described below. It is to be expressly understood that this exemplary embodiment is for descriptive purposes only and is not meant to limit the scope of the invention.

The communications content, such as recorded video segments, audio segments, pictorial segments, graphical segments, textual segments, music segments etc. are encoded in suitable formats to enable them to be used as elements in a communications product. This communications product will then be capable of being streamed in an on-demand capacity using ActiveX components, Macromedia Flash components or other media player components.

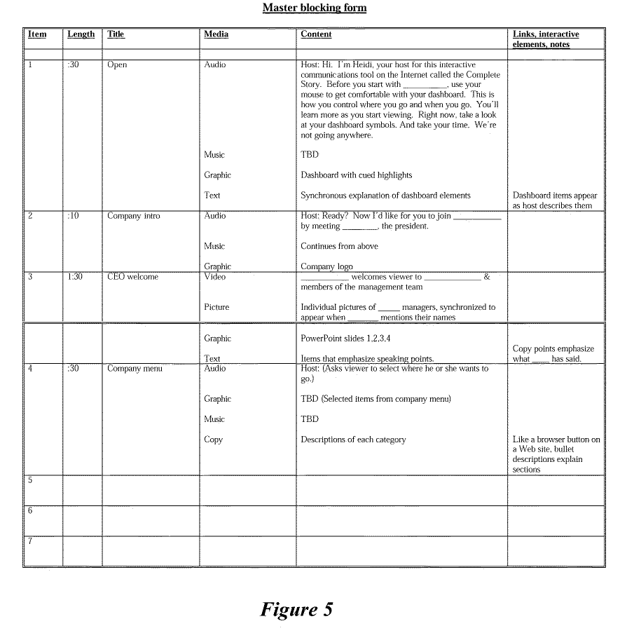

The media player interface 50 is then created. This can be a stock media player or a customized media player, for example having a company's logos, information about the company or other custom features. A blocking form, such as shown in FIG. 5, is then used to create a database that catalogues the segments. This places all of the media components in a timed, or cued fashion. For example, while a video is playing about a location in the video window 52, a map can be synchronously cued in the content window 60 while text highlights about the video may be shown in the footer 90. While the preferred embodiment utilizes this above comprehensive time line to synchronize the different formats of media content, other forms of synchronization techniques may be used as well.

The media content may be stored on the server of the host, in a remote database, or even delivered and stored on the user's computer. In a preferred embodiment, the media content may be stored in a remote database and delivered upon cue.

Digital production of the final product is then commenced until the product is finalized. Alternatively, the final product may be delivered live, such as a lecture in distance learning environment. The differing media content may be delivered from remote databases on cue with the live performance or upon cues that are either built into the live content or by manual intervention.

In this embodiment, an indexable file menu selection 100 is created. This allows the user to select a particular segment for immediate access rather than fast forwarding through the media content. Also, the media player interface 50 will also include the dashboard controls 54 to allow the user to manipulate the content delivery.

The final encoded product is then stored on streaming media server(s) 30 or delivered live. The media player given a link, such as a Uniform Resource Locater (URL) link so that it may be easily accessible from any location or if desired from secure locations. The user simply utilizes a browser that supports the media player, accesses the link for that media player, and receives the communication from the host. Typically, the content is displayed sequentially unless the user goes to the indexable menu and selects a particular content segment. At that point, the particular content segment is played in the media player interface. Also, if the interactive component is available, the user may utilize that component to interact with the host as well. Once the user is finished receiving the communication, the user simply exists from the media player.

Applications

The present invention may be applied in many different forms. For example, and not limited thereto, the preferred embodiment described above may be used in a distance learning program. The information is presented to remote users via a network or Internet transmission or even through a DVD. The user is presented the information in synchronized audio/video/textual/pictorial/graphical forms. The user is able to ask questions via instant messenger/email/video/audio back to the host. The user may even be tested interactively through the test window. The student may select program segments as desired without scrolling through the entire communication.

Another application of a preferred embodiment of the present invention is for collaborative environments. For example, a company may want to present information, such as an engineering meeting, a sales presentation, marketing meeting, dealer meeting or other applications, to multiple remote sites. The information is stored on a remote database that is accessible either through the media player or directly by the users. The host presents the information, live or stored, via the media player interface with synchronized content, such as presentation materials, files, or other content from the remote database. Users at the remote site may participate through the instant messaging components, email components, chat room components or other interactive components or combinations of these components.

Other applications may include marketing, instructional, ecommerce websites, electronic retailing, professional development, translations, bookstores or many other applications that require one or more forms of communications.

Another application is to utilize the media player of the present invention with a kiosk. The kiosk may be at any suitable location for use by the user. The user may interact with the media player and host by a touch screen or by other conventional or unconventional interfaces.

These and other features of the present invention may be used either in combination or separable from one another. The above descriptive embodiments are intended for explanatory purposes and are not intended to limit the scope of the present invention.

1. A media player for presenting communications to remote users, said media player comprises:
a graphical user interface;
a first window on said graphical user interface presenting a media communication;
an indexable menu selection to allow a user to select a desired segment of a media communications; and
a retrieval mechanism for retrieving a selected segment for presentation in said first window.

2. The media player of claim 1 wherein said media player further includes:
a second window on said graphical user interface for presenting a media communication; and
a synchronization component for synchronizing the media communication in said second window with the media component in said first window.

3. The media player of claim 1 wherein said media player further includes:
a plurality of windows on said graphical user interface for presenting media communications; and
a synchronization component that synchronizes the media communications in each of said windows with the media communications in said first window.

4. The media player of claim 1 wherein said media player further includes:
an interactive component for allowing communication between a host presenting said media communication and a user of said graphical user interface.

5. The media player of claim 1 wherein said media player further includes:
an interactive component for allowing communication between multiple users of said media player.

6. The media player of claim 1 wherein said media player further includes:
a remote database; and
a component for retrieving information from said remote database on cue with the presentation of the media communication in said first window.

7. The media player of claim 1 wherein said graphical user interface is displayed on a browser.

8. The media player of claim 1 wherein said media player further includes:
the media communication presented in said first window is in an audio-video format;
a second window presenting information in a text-graphic format; and
a synchronization component for synchronizing the information presenting in said second window with the media communication presented in said first window.

9. The media player of claim 1 wherein said media player further includes:
the media communication presented in said first window is in an audio-video format;
a second window presenting information in a text-graphic format;
a synchronization component for synchronizing the information presenting in said second window with the media communication presented in said first window; and
an interactive component for allowing a user to provide information to a host supplying said media communication.

10. The media player of claim 1 wherein said media player further includes:
the media communication presented in said first window is in an audio-video format;
a second window presenting information in a text-graphic format;
a synchronization component for synchronizing the information presenting in said second window with the media communication presented in said first window;
an interactive component for allowing a user to provide information to a host supplying said media communication; and
an interactive component for allowing a user to provide and receive information with other users of said media player.

11. A media player for presenting communications to remote users, said media player comprises:
a graphical user interface;
a first window on said graphical user interface presenting a media communication;
a second window on said graphical user interface for presenting a media communication; and
a synchronization component for synchronizing the media communication in said second window with the media component in said first window.

12. The media player of claim 11 wherein said media player further includes:
an indexable menu selection to allow a user to select a desired segment of a media communications; and
a retrieval mechanism for retrieving a selected segment for presentation in said first window.

13. The media player of claim 11 wherein said media player further includes:
a plurality of windows on said graphical user interface for presenting media communications; and
a synchronization component that synchronizes the media communications in each of said windows with the media communications in said first window.

14. The media player of claim 11 wherein said media player further includes:
an interactive component for allowing communication between a host presenting said media communication and a user of said graphical user interface.

15. The media player of claim 11 wherein said media player further includes:
an interactive component for allowing communication between multiple users of said media player.

16. The media player of claim 11 wherein said media player further includes:
a remote database; and
a component for retrieving information from said remote database on cue with the presentation of the media communication in said first window.

17. The media player of claim 11 wherein said graphical user interface is displayed on a browser.

18. The media player of claim 11 wherein said media player further includes:
the media communication presented in said first window is in an audio-video format;
a second window presenting information in a text-graphic format; and
a synchronization component for synchronizing the information presenting in said second window with the media communication presented in said first window.

19. The media player of claim 11 wherein said media player further includes:
the media communication presented in said first window is in an audio-video format;
a second window presenting information in a text-graphic format;
a synchronization component for synchronizing the information presenting in said second window with the media communication presented in said first window; and
an interactive component for allowing a user to provide information to a host supplying said media communication.

20. The media player of claim 11 wherein said media player further includes:
the media communication presented in said first window is in an audio-video format;
a second window presenting information in a text-graphic format;
a synchronization component for synchronizing the information presenting in said second window with the media communication presented in said first window;
an interactive component for allowing a user to provide information to a host supplying said media communication; and
an interactive component for allowing a user to provide and receive information with other users of said media player.

21. A media player for presenting communications to remote users, said media player comprises:
a graphical user interface;
a first window on said graphical user interface presenting a media communication; and
an interactive component for allowing communication between a host presenting said media communication and a user of said graphical user interface.

22. The media player of claim 21 wherein said media player further includes:
a second window on said graphical user interface for presenting a media communication; and
a synchronization component for synchronizing the media communication in said second window with the media component in said first window.

23. The media player of claim 21 wherein said media player further includes:
an indexable menu selection to allow a user to select a desired segment of a media communications; and
a retrieval mechanism for retrieving a selected segment for presentation in said first window.

24. The media player of claim 21 wherein said media player further includes:
a plurality of windows on said graphical user interface for presenting media communications; and
a synchronization component that synchronizes the media communications in each of said windows with the media communications in said first window.

25. The media player of claim 21 wherein said media player further includes:
an interactive component for allowing communication between multiple users of said media player.

26. The media player of claim 21 wherein said media player further includes:
a remote database; and
a component for retrieving information from said remote database on cue with the presentation of the media communication in said first window.

27. The media player of claim 11 wherein said graphical user interface is displayed on a browser.

28. The media player of claim 12 wherein said media player further includes:
the media communication presented in said first window is in an audio-video format;
a second window presenting information in a text-graphic format; and
a synchronization component for synchronizing the information presenting in said second window with the media communication presented in said first window.

29. The media player of claim 21 wherein said media player further includes:
the media communication presented in said first window is in an audio-video format;
a second window presenting information in a text-graphic format;
a synchronization component for synchronizing the information presenting in said second window with the media communication presented in said first window; and
an interactive component for allowing a user to provide information to a host supplying said media communication.

30. The media player of claim 21 wherein said media player further includes:
the media communication presented in said first window is in an audio-video format;
a second window presenting information in a text-graphic format;
a synchronization component for synchronizing the information presenting in said second window with the media communication presented in said first window; and
an interactive component for allowing a user to provide and receive information with other users of said media player.

31.
